(19) United States
(12) Patent Application Publication
(10) Pub. No.: US 2010/0089388 A1
(43) Pub. Date: Apr. 15, 2010

(54) APERTURE CLOSURE APPARATUS

(76) Inventor: Bruce Stanley GUNTON, Yoxall (GB)

Correspondence Address: CHERNOFF, VILHAUER, MCCLUNG & STENZEL, LLP, 601 SW Second Avenue, Suite 1600, Portland, OR, 97204, US

(21) Appl. No.: 12/529,317

(22) PCT Filed: Feb. 20, 2008
(86) PCT No.: PCT/GB2008/000573

§ 371 Date: Aug. 31, 2009

(30) Foreign Application Priority Data
Mar. 3, 2007 (GB) 0704145.2

(51) Int. Cl. F24J 2/40; F16K 17/36

(52) U.S. Cl. 126/572; 137/38

(57) ABSTRACT

Apparatus in the form of a sash window has sashes (16a, 16b) to control an opening (18). Drive arrangements (20a, 20b) are mounted within the frame and electrically powered from batteries (30), to allow the sashes (16a, 16b) to be opened or closed by remote control (40).

The present invention relates to apparatus for opening and closing apertures, such as windows and doors.

Embodiments of the invention provide apparatus comprising:

a frame member defining at least part of the periphery of an aperture;

a movable element for moving relative to the frame member to open and close the aperture; and

a drive arrangement for driving the movable element, the drive arrangement being housed within one of the frame member; the movable element; and the frame member and movable element in combination.

The drive arrangement may include a motor and a control arrangement for controlling the motor. The drive arrangement may include two motors driving respective sides of a movable element. The arrangement may further comprise a control arrangement operable to control the relative speeds of the motors, during use, to control the alignment of the movable element as it moves. The control arrangement may be operable to slow the or each motor as the movable element reaches a limit of travel in at least one direction. The control arrangement may be operable to accelerate the pr each motor as the movable element moves from at least one, limit of travel. The drive arrangement may be powered by batteries housed within one of the frame member, the movable element and the frame member and movable element in combination.

The apparatus may comprise a charging arrangement for the batteries. The charging arrangement may be operable when the movable element is closed. The charging arrangement may be operable to provide a warning when the batteries are being charged. The charging arrangement may comprise an inductively coupled power supply. The charging element may comprise sliding contacts for providing electrical connection to the movable element. The charging arrangement may comprise a renewable source of power such as a solar panel, wind generator or thermo-electric generator deriving power from a temperature difference. The thermo-electric generator may derive power from the temperature difference between the inside and outside of a building in which the apparatus is installed.

The apparatus may comprise a battery monitor for monitoring the charge state of the batteries. The battery monitor may provide a warning when the charge state is or passes below a threshold level. A further warning signal may be provided when the charge state is or passes below a second threshold level.

The or each warning signal may be an audible signal. The or a warning may be a modification of operation of the apparatus. At least one function of the apparatus may be inhibited, to provide the or a warning. The apparatus may comprise a remote control transmitter, wherein response to the remote control transmitter is modified or inhibited to provide the or a warning.

The apparatus may further comprise a proximity sensor. The proximity sensor may be carried by the movable element. The proximity sensor may be carried by the frame member. The apparatus may provide a warning in the event that the proximity sensor is activated. The warning may be audible. The apparatus may be operable to stop the movable element when the proximity sensor is activated. The apparatus may be operable to re-open the movable element when the proximity sensor is activated, unless the movable element is at or close to its fully closed position.

The apparatus may further comprise user controls for instructing operation of the apparatus. The user controls may include a remote control transmitter. The user controls may be operable to open the aperture to a predetermined degree. The user controls may be operable to disable the drive arrangement, to lock the movable member.

The movable element and the frame member may form a sash window arrangement.

Embodiments of the invention also provide a system comprising a plurality of apparatus according to any of the preceding definitions, further comprising a common user control arrangement operable to control operation of the plurality of movable elements.

Example embodiments of the present invention will now be described in more detail, by way of example only, and with reference to the accompanying drawings, in which:

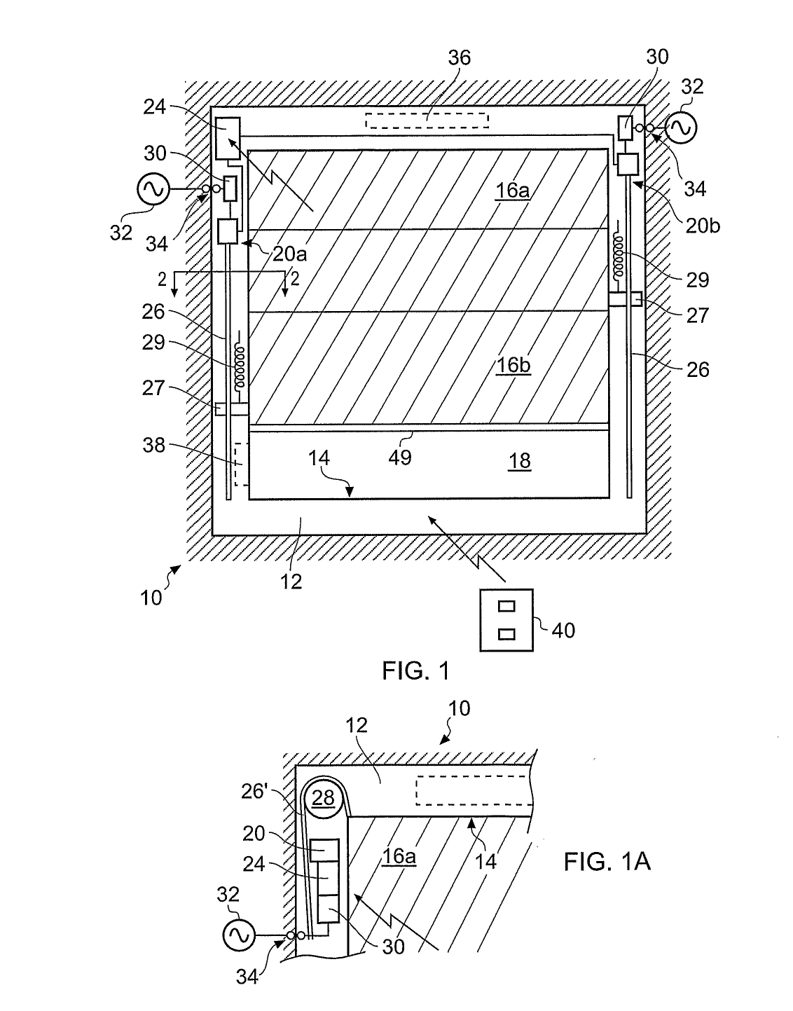

FIG. 1 is a schematic elevation of apparatus according to the present invention, installed in an aperture in a wall;

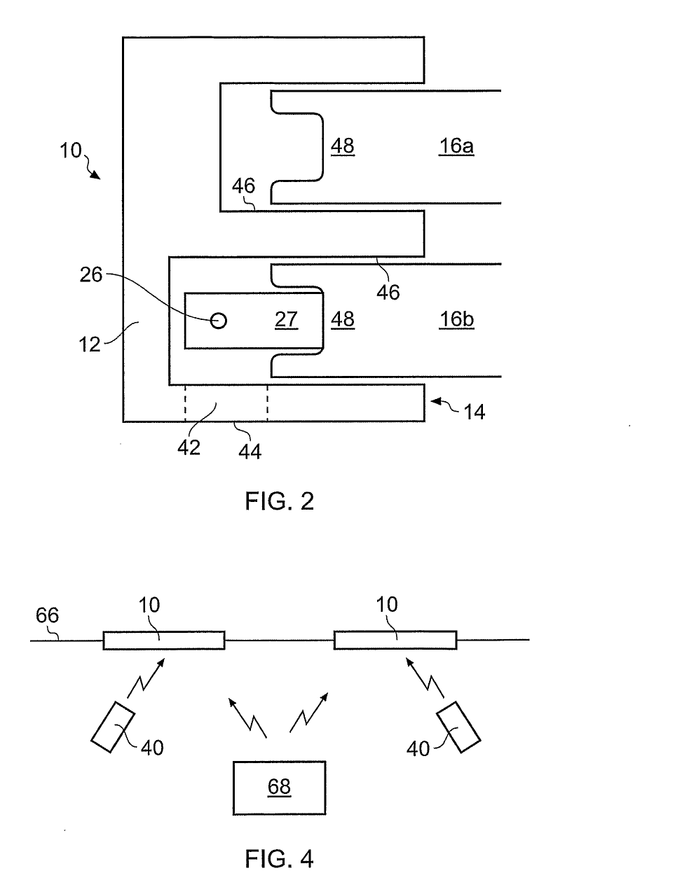

FIG. 2 is a section through the frame of the apparatus of FIG. 1, at the line 2-2 in FIG. 1;

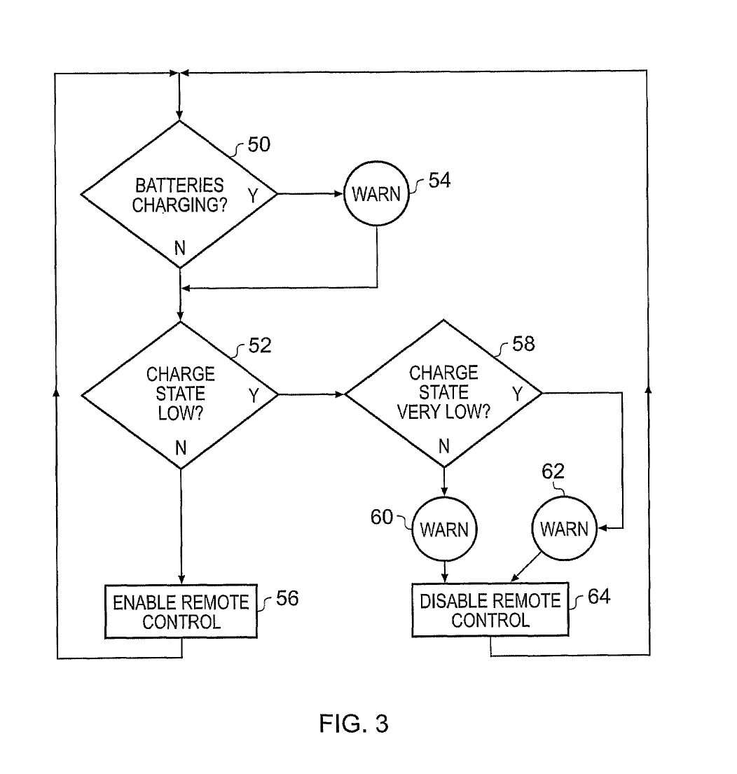

FIG. 3 is a flow diagram of a monitoring process performed within the apparatus of FIG. 1; and

FIG. 4 is a highly schematic plan of a system incorporating multiple apparatus of the type illustrated in FIGS. 1 and 2.

FIG. 1 shows apparatus 10 in the form of a sash window. The apparatus 10 comprises a frame member 12 which may be constructed from several lengths (typically four) of timber, or from extrusions. The extrusion may be of plastics or metal, and may be a plastics extrusion containing metal reinforcement. The frame 12 defines the whole of the periphery of an aperture 14, in this example. In other examples, the frame 12 may be designed to define only part of the periphery.

Two movable elements 16a, 16b, in the form of sashes for the sash window 10, are provided for moving up and down within the frame 12 in order to open or close the aperture 14. In the condition illustrated in FIG. 1, the upper sash 16a is fully closed, at its uppermost position. The lower sash 16b is partially open, having moved up from its lowermost position to leave an opening 18. Consequently, the sashes partly overlap; as indicated by the diagonal shading in FIG. 1.

A drive arrangement 20 is provided for driving each sash 16a, 16b. In this example, separate drive arrangements 20a, 20b are provided for each sash 16a, 16b. The drive arrangements 20a, 20b are housed within the frame member 12, preferably within the upright legs of the frame 12. Each drive arrangement 20a, 20b includes an electric motor used to drive the respective sash 16. In the example of FIG. 1, which shows extruded plastic frame members 12, the motors 20 drive the sashes by rotating an elongated threaded or helical member 26 carrying a collar 27 which rides up or down the thread or helix, as the member. 26 turns. The collar 27 is attached to the corresponding sash. Accordingly, the sash can be moved in either direction by driving the motor in a corresponding direction. Counterbalancing is provided by spring arrangements 29, shown schematically and only in FIG. 1.

In an alternative arrangement (part of which is illustrated in FIG. 1a), the sashes of a timber framed sash window are controlled by motors 20 driving conventional sash cords 26′ which run over pulleys 28, connecting to the sash 16 to form an endless loop.

In either example, each motor 20 is controlled by a controller 24 to move the corresponding sash 16 up or down, when required, to open or close the aperture 14.

Power for the motors 20 and for the controller 24 is provided by batteries 30 which are also housed within the frame 12, in this example. FIG. 1 illustrates two battery packs 30, for respective motors 20. Alternatively, a single battery could be used to supply both motors.

Arrangements are provided for charging the batteries 30. Battery charge may be drawn from a mains supply 32, conveniently by means of coils 34 providing inductive coupling from the supply 32 to the batteries 30, to avoid the need for wired connections to the components housed within the frame 12. The coils 34 may be driven by an oscillator circuit at a frequency higher than the mains supply frequency. The oscillator frequency may be in the region of 125 kHz. The pick-up coil 34 (at the window frame side of the inductive coupling) may drive a rectifier to provide DC power for the batteries 30.

Alternatively, or in addition, charging may be available from a renewable source of power illustrated schematically at 36. This may be a solar panel incorporated in an outwardly facing surface of the frame 12, or a wind generator exposed to external weather, or a thermo-electric generator. A thermo-electric generator derives power from a temperature difference. In one example, the temperature difference may be between the inside and outside of the building in which the apparatus 10 is installed in an external wall.

In other examples, some or all of the motors, batteries, controllers and associated apparatus may be housed within the movable elements. In that event, electrical connections to the apparatus within the movable member may be inductive or by means of sliding contacts. The electrical connections provide charging when the movable member is closed, at least, in one example. Sliding contacts may allow unbroken electrical connection, while the movable member is moving.

User controls are provided for operation of the apparatus 10. The user controls may include a control panel 38 mounted on the frame 12 and including one or more control buttons or other actuators through which instructions can be issued for the controller 24. In the example being described, a remote control transmitter 40 is provided for transmitting instructions wirelessly to the controller 24, by radio transmission, infrared transmission or other wireless technology.

In this example, the user controls 38, 40 allow a user to open or close a chosen sash 16 by an amount chosen by the user, or to provide trickle ventilation by opening a predetermined sash 16 to a predetermined degree (for example to move the upper sash 16 down by a small amount, to leave a small ventilation gap at the top of the aperture 14). The user controls may also be operable to disable the motors 20, thereby locking the sashes 16, or there may be locks, such as solenoid-operated locks, which the user may elect to engage.

FIG. 2 shows a section through the frame 12. The frame is an extruded profile. An equivalent profile is used at the other side of the aperture 14 and at the top and bottom of the frame. The profile includes a cavity 42 for housing components such as the motor 20, the controller 24, batteries 30, and counterbalance arrangement 29. A removable cover 44 is provided for access to the cavity 42, such as for maintenance. In one example, the motor and counterbalance arrangement may be housed in a side (vertical) extrusion, with the batteries and controller housed in a horizontal (top or bottom) extrusion.

The frame extrusion also provides channels 46 in which the edges 48 of the sashes 16a, 16b can run. The threaded member 26 or sash cord 26′ is shown in FIG. 2, running up the channel 46 in which one of the sashes 16 is received, and connected to the sash. A similar arrangement for the threaded member 26 or sash cord 26′ of the other sash 16 is provided on the other side of the aperture 14.

The lower edge of the sash 16b may carry a proximity sensor 49 which may function by contact or in a capacitive or inductive manner. The proximity sensor 49 is monitored by the controller 24. In the event that the proximity sensor 49 senses a body, while the sash 16 is closing, the sash will stop. The sash 16b will re-open unless the sash 16b is nearly fully closed, in which case the sash 16b will stay at the stopped position. These arrangements provide safety against obstructions, particularly by body parts.

In addition, the proximity sensor 49 may be used for security purposes. Thus, the proximity sensor 49 may be connected to an intruder alarm. A body approaching the window 10, when the alarm is set, can be sensed by the proximity sensor 49 as representing an intruder.

In an alternative arrangement, a proximity sensor may be mounted on the frame 12.

The proximity sensor may also be used to provide an alarm output when a body is detected while the window is stationary and in an open position.

In any situation in which a body is sensed, the proximity sensor may issue an audible alarm, which may be different in different situations, such as when the movable member is moving or stationary.

The controller 24 performs various monitoring functions, particularly in relation to the batteries 30. Battery state is important to ensure that movement of the sashes 16 is not disabled by drained batteries, which could leave the sashes 16 at an open position, with consequent problems of security, weather ingress, safety and the like. Accordingly, the controller 24 repeatedly executes a sequence of checks and responses, illustrated schematically in FIG. 3. It should be noted that the sequence in which these operations are described and illustrated is for example only. Many other combinations or orders of operation could be used.

At step 50, the controller checks if the batteries 30 are currently being charged. If not, the process moves to step 52. If the batteries are currently charging, a warning is provided at 54, which may be a periodic audible warning.

At step 52, the controller 24 checks the current charge state of the batteries 30. If the charge state is adequate, being above a predetermined threshold level, the process moves to step 56. If the charge state is below the predetermined threshold level, indicating a low charge state, a further check is made at step 58 to see if the charge state is also below a second, lower predetermined threshold level, indicating that the charge state is very low. If the charge state is low, but not very low, a warning is provided at 60, which may be an audible warning readily distinguishable from the warning at 54.

If the charge state is adjudged at step 58 to be very low, a warning is provided at step 62, which may be an audible warning readily distinguishable from the warnings 54, 60.

If either of the warnings 60, 62 have been given, the controller 24 inhibits response to the remote control transmitter 40, at step 64. This function is not inhibited primarily to avoid further drain on the batteries 30, but to provide a clear indication to the user that the battery charge state is low or very low. The user must then use the control panel 38. It is expected that this will encourage a user to refrain from seeking to move the sashes 16 (except, perhaps to close them), until the batteries have been allowed to recharge. While the remote control is disabled (step 64), the controller 24 may respond to any user use of the transmitter 40 by providing a further warning signal to confirm that the apparatus is not faulty, but has inhibited the function in consequence of the battery state.

Following step 64, the sequence recommences at step 50.

At step 56, normal remote control operation is enabled (if currently disabled) and the sequence then returns to step 50.

FIG. 4 illustrates a system in which multiple sets of apparatus of the type described above can be used together, for example at separate windows in a single building. In this example, each sash window 10 is installed in a wall 66. Each window 10 is illustrated with a dedicated transmitter 40 for controlling only that window. Alternatively, a single transmitter could have multiple controls for controlling respective windows 10. This allows individual windows to be controlled in the manner described above. In addition, central control functions are provided. In FIG. 4, these are illustrated as transmissions from a central control 68, transmitting to all of the windows 10. Alternatively, a single, multi-purpose transmitter 40 may be able to issue commands to individual windows 10, or simultaneously to all windows.

The provision of centralised control allows a number of convenient operations. For example, a user may instruct all windows to close (if not already closed), for example when leaving the premises. Alternatively, a user may instruct all windows to open, particularly to a ventilation position, for example when entering the premises.

Central controls to the various windows may be issued simultaneously or staged over a short period of time, particularly if all of the windows are operating from a single power supply, to avoid excessive load on the supply.

The control panel 38, the controller 40 or the central control 68 may be used to instruct the controller 24 to disable movement of the sashes, so that the window is locked.

The description above has been in relation to sash windows, but may be applied to other arrangements having movable elements, such as swing windows. These may have lights which open by swinging about a single axis or a selected one of two axes. Either, or both motions may be driven by an arrangement of the type described above, with appropriate couplings between the or each motor and the movable element or elements.

Many variations and modifications can be made to the apparatus described above, without departing from the scope of the present invention. In the examples described above, each movable member is driven by a respective motor, and a common controller is used to control the motors. Other alternatives could be used. Each movable member could be driven by two motors, respectively to either side, in which case a single controller is preferred, able to monitor the movement of each motor to ensure that it is uniform and thus not likely to cause the movable member to twist and jam. Larger windows can jam as a result of differences in friction either side of the sash and differences in motor efficiency, which necessitates controlling the speed of both sides of a sash window by controlling the relative speed of the two motors. (A sash window arrangement having two movable members would therefore require four motors). It is therefore desirable for the relative rate of movement of either side of a sash to be monitored and the relative speed of the two motors of that sash to be controlled to ensure that the sash does not jam.

Control of the two motors may be accomplished by the provision of a tachometer output from each motor, which is monitored by the Controller 24. The Controller 24 will adjust the speed of one or both motors to ensure that they are substantially uniform.

The motor speeds may also be monitored by sensing commutator current pulses arising in the motors, or by monitoring the rotating magnetic field of each motor by provision of a sensor, which may be positioned either within or near each motor body.

The speed of a motor may be varied by adjustment of the motor supply voltage, by adjusting the conductivity of one or more switching devices in a bridge circuit used to supply motor current, or by pulse width modulation of the supply to the motor. Pulse width modulation can be accomplished by rapid on and off switching one of the switching devices in a switching Bridge.

The speed of both motors may be controlled in a similar fashion, or one motor may be controlled to stay in step with the other. The relative motor speeds may be adjusted by changing the switching, rate of one switching device in a bridge controlling one motor relative to the switching rate of a device in a second bridge controlling the second motor. In any of the examples described above, the controller 24 may reduce the speed of each sash just prior to the limit of travel of the sash in both directions, to provide a soft stop rather than a possible abrupt mechanical stop.

Many different types and forms of components can be chosen, other than those described and illustrated. The controller 24 may be based on a microprocessor operating under appropriate software instructions or may be a dedicated circuit such as an application specific integrated circuit (ASIC). Many other shapes of extrusion can be used for the frame 12.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Apparatus comprising:
a frame member defining at least part of the periphery of an aperture;
a movable element for moving relative to the frame member to open and close the aperture; and
a drive arrangement for driving the movable element, the drive arrangement being housed within one of the frame member; the movable element; and the frame member and movable element in combination.

2. Apparatus according to claim 1, wherein the drive arrangement includes a motor and a control arrangement for controlling the motor.

3. Apparatus according to claim 1, wherein the drive arrangement includes two motors driving respective sides of a movable element.

4. Apparatus according to claim 3, further comprising a control arrangement operable to control the relative speeds of the motors, during use, to control the alignment of the movable element as it moves.

5. Apparatus according to claim 2, wherein the control arrangement is operable to slow the or each motor as the movable element reaches a limit of travel in at least one direction.

6. Apparatus according to claim 2, wherein the control arrangement is operable to accelerate the or each motor as the movable element moves from at least one limit of travel.

7. Apparatus according to claim 1, wherein the drive arrangement is powered by batteries housed within one of the frame member; the movable element; and the frame member and movable element in combination.

8. Apparatus according to claim 7, comprising a charging arrangement for the batteries.

9. Apparatus according to claim 8, wherein the charging arrangement is operable when the movable element is closed.

10. (canceled)

11. Apparatus according to claim 8, wherein the charging arrangement comprises an inductively coupled power supply.

12. Apparatus according to claim 8, wherein the charging element comprises sliding contacts for providing electrical connection to the movable element.

13. Apparatus according to claim 8, wherein the charging arrangement comprises a renewable source of power such as a solar panel, wind generator or thermo-electric generator deriving power from a temperature difference.

14. Apparatus according to claim 13, wherein the thermo-electric generator derives power from the temperature difference between the inside and outside of a building in which the apparatus is installed.

15-19. (canceled)

20. Apparatus according to claim 8, wherein at least one function of the apparatus is inhibited, to provide the or a warning.

21. Apparatus according to claim 20, wherein the apparatus comprises a remote control transmitter, wherein response to the remote control transmitter is modified or inhibited to provide the warning.

22. Apparatus according to claim 1, further comprising a proximity sensor.

23-26. (canceled)

27. Apparatus according to claim 22, wherein the apparatus is operable to stop the movable element when the proximity sensor is activated.

28. Apparatus according to claim 22, wherein the apparatus is operable to re-open the movable element when the proximity sensor is activated, unless the movable element is at or close to its fully closed position.

29-31. (canceled)

32. Apparatus according to claim 1, wherein the user controls are operable to disable the drive arrangement, to lock the movable member.

33. Apparatus according to claim 1, wherein the movable element and the frame member form a sash window arrangement.

34-36. (canceled)

37. Apparatus according to claim 8, further comprising a battery monitor for monitoring the charge state of the batteries, wherein the battery monitor provides a warning when the charge state is or passes below a threshold level, and wherein the or a warning is a modification of operation of the apparatus, and wherein at least one function of the apparatus is inhibited, to provide the warning.
